(19) United States
(12) Patent Application Publication
(10) Pub. No.: US 2014/0326832 A1
(43) Pub. Date: Nov. 6, 2014

(54) METHOD AND SYSTEM FOR FEEDING JET ENGINES

(71) Applicant: Alexander Olegovich Maiboroda, Rostov-na-Donu (RU)

(72) Inventor: Alexander Olegovich MAIBORODA, Rostov-na-Donu (RU)

(21) Appl. No.: 14/331,369

(22) Filed: Jul. 15, 2014

Related U.S. Application Data
(63) Continuation of application No. 13/202,304, filed on Aug. 18, 2011, now abandoned.

(30) Foreign Application Priority Data
Feb. 20, 2009 (RU) 2009106127

(51) Int. Cl. B64G 1/40

(52) U.S. Cl. CPC B64G 1/402
USPC 244/172.2

(57) ABSTRACT

A method for feeding a ramjet of a spacecraft beyond the dense layers of the atmosphere includes providing a fueling apparatus having an amount of a propellant for feeding a ramjet of the spacecraft. The propellant is ejected from the fueling apparatus in form of a solid and flexible propellant cord, wherein said propellant cord being placed on a flight path of the spacecraft. The solid and flexible propellant cord enters into the ramjet of the spacecraft. At least a part of a propellant of the solid and flexible propellant cord is used for feeding the ramjet. The cord includes an amount of a propellant stabilized in density relating to an environmental air by introducing one or more linear elements selected from ribbons, threads, or fibers, reticulate or membrane structures.

### RELATED APPLICATIONS

This application is a Continuation of U.S. patent application Ser. No. 13/202,304, filed Aug. 18, 2011, which is a §371 of PCT/RU2009/000739, filed Dec. 28, 2009, the entire contents of all of which are incorporated by reference herein as if fully set forth.

### FIELD OF THE INVENTION

The invention relates to rocket production and astronautics, in particular to methods and space transport systems for delivering cargoes.

### BACKGROUND

The task of reducing costs for transporting cargo into space is complicated by the fact that the greater part of cargo is made up by fuel for its transportation which has to be delivered from the Earth.

There is known a method for delivering cargoes into space with the aid of single-step and multi-step (composite) rockets. K. E. Tsiolkovsky has proposed to change approach to creation of rocket systems. K. E. Tsiolkovsky's idea supplemented by Y. I. Perelman and completed by M. K. Tikhonravov about creation of “package of rockets” received further development in a number of patents (U.S. Pat. No. 3,369,771, U.S. Pat. No. 4,834,324, U.S. Pat. No. 5,141,181 . . . etc.).

The mentioned works consider method of clustering several rockets tightly banded together before start into a so-called package where fuel is transferred from one rocket to another.

However such a “package of rockets” is considerably bulky on launch pad that makes steep demands of launcher.

There are known methods of refueling during the flight of spacecrafts (SC) with fluid-rocket engines (FRE) with the aid of flying fueling apparatus (FFA) by means of docking, fuel transmission through hose pipe connecting apparatuses, or without a hose pipe—by fuel transfusion as an open jet of working substance/propellant.

These methods provide reduction in costs of prestarting services on launch pad which depend on SC launching mass and get reduced with downsizing of mass and dimensioning characteristics of SC.

The essence of one of methods for delivering cargoes into space (patent RU No. 2085448) comes to simultaneous start and further joint flight of vertical takeoff spacecraft with fluid-reactive engine and fueling apparatus with vertical takeoff where in course of joint and parallel flight fuel transmission is fulfilled with the aid of a flexible fuel transmission means by which they get connected already on the starting point before takeoff.

The drawback of this method is initiation of additional aerodynamic loads on the system, weighting of flexible fuel transmission means for the purpose of flutter prevention, increase of construction total mass in result of substantial increase in length of fuel-filled pipeline system, additional fuel consumption to carry out parallel flight with consideration of aerodynamic force affecting the pipeline system and tending to draw both apparatuses together.

The essence of another method for delivering cargoes into space proposed by G. A. Crocco on Forth Astronautical Congress in Zurich in 1953 (G. A. Crocco. Le ravitallement dans et le probleme des polistades. The Fourth Astronautical Congress “Space-Flight Problems” Published by the Swiss Astronautical and Aeronautical Federation, pp. 152-160) stipulates launch of independent rockets of two types: a rocket with net load and one or more rockets with fuel. Independent rockets are not clustered firmly into a single construction during the start and fly freely separately from each other that makes it possible to considerably simplify the launcher and reduce total weight of rockets in comparison with firmly clustered “package of rockets”. At a desired altitude both rockets are flying synchronously and parallel for some time in course of which there performed free throwing of fuel in a directed jet from the containers the rocket with fuel into the opening of rocket with net load.

The method of fuel transmission in a form of free ejection of directed jet causes a number of problems. Liquid fuel jet can't preserve integrity on big distances; it loses homogeneity, splits into fractions—pulverizes. As well as its hard to provide exact direction of fuel jet flight on big distances because of inevitable dispersion of initial speeds and angles of jet ejection under conditions of vibrations and oscillations occurring in course of flight.

The main drawback of the considered methods is that fuel stock carried by fueling apparatus needs to be accelerated up to the speed of spacecraft under refueling. It doesn't give any energy advantages to the given methods in comparison with traditional method where all fuel is stored in one starting SC.

There is known a method including air intake from the atmosphere, its compression, liquation and separation into oxygen and nitrogen, oxygen accumulation straight in course of SC flight with its further consumption in FRE including same on sectors of acceleration beyond the dense layers of atmosphere where there is already no possibility for oxygen intake (I. Afanasiev, “Sostoyanie rabot po “kosmicheskim samoletam” in “Novosti Kosmonavtiki” magazine (registered in RF State Press Committee No 0110293. ISSN 1561-1078):http://www.novosti-kosmonavtiki.ru/content/numbers/184-5/30.shtm).

This method provides reduction of SC launching mass on account of self refueling with oxygen in course of flight without a flying fueling apparatus and this eliminates the drawbacks of previous methods.

Still on high speeds of flight there grow inevitable loses of heat taken from air for its liquation that makes it impossible to use this method in those cases when power inputs into dynamic compression and liquation of oxygen become commensurable with energy-release from fuel combustion in the received oxygen. Besides it is required to use complicated system of thermal exchange between incoming air, fuel and/or additional working substance/propellants.

There is known a method of air intake from the atmosphere, its dynamical compression and consumption (without cooling and liquation) as oxidizer and/or heated working body in jet engines of propulsive type or propulsive jet engines (PJE) (also known as ramjets). This method provides reduction of SC launching mass due to consumption of main oxygen mass not from its on-board stocks but from an external source—the atmosphere for reaching the speeds of flight close to the first cosmic velocity (Wikipedia: http://ru.wikipedia.org/wiki/Air-jet engine).

When PJE is working on hypersonic speeds starting from 5 M (M—the Mach number) there appear several technical problems. These are difficulties of mixing a combustible with air, engine thermal surcharge control, in particular control of all front edges of air inlet overheating. For hypersonic speeds flights there required special constructions and materials not only for engines but for spacecraft as well.

There is known a method proposed by A. I. Merkulov based on application of propulsive jet engines/ramjets (PJE) as space air-jet engines for spacecrafts acceleration in the superstandard layers up to the speed of V=15-18 km/s (50-60 M) for the purpose of realization of interplanetary flights or for other purposes like for example reduction of flight period in near-earth space (Izvestia Akademii Nauk USSR, ENERGETIKA I TRANSPORT, 1965. Problema kosmicheskih vozdushno-reaktivnih dvigateley, I. A. Merkulov, pp. 159-172/News from USSR Science Academy, Section Energetic_and Transport, 1965, I. A. Merkulov: a problem of space propulsion jet engines/).

According to I. A. Merkulov functioning of space PJEs can be fulfilled not only at the account of the known schemes of heat supply to air stream or combination of heat with additional mass of working substance/propellant from on-board stocks, but also basing on transmission of only one additional mass of inert (incombustible) substance on account of usage of total kinetic energy of working substance/propellant (WS) and SC in accord with the theorem formulated by the author “about equivalence of additional masses and additional energy from the point of view of getting thrust” (p. 166). Chemical fuel elimination solves following problems: engine protection from erosion in high-temperature stream of oxidizing environment; control of combustible supply under conditions of continuously changing air stream as a result of SC acceleration and ensuring of its normal mixing and burning up in conditions of hypersonic gas stream; provides substantial increase of specific pulse (500-750 kg·s/kg for air, according to Merkulov) starting from M=30-40 if compared with values which prospective fluid rocket engines may have. Usage of external sources in the form of atmospheric air for SC acceleration within the range of cosmic velocities from 1^{st} to 3^{rd} ones reduces fuel stocks and increases the share of net load.

In spite of the mentioned advantages the main drawback of space PJE project is usage of superstandard layers as the source of fuel or working substance/propellant components. This drawback causes three main problems.

Consumption of working substance/propellant from superstandard layers requires compression in diffuser of discharged air stream entering the engine, that causes braking and reduces PJE draught as well as irreversible losses of mechanical energy. These losses, according to I. A. Merkulov, are at least one degree higher than losses of energy in result of gas friction in course of its flowing along the walls of combustion chamber and nozzle in comparison with losses accompanying process of air compression in diffuser. As the author himself notes engine thrust was considered regardless of external resistance of SC motor nacelle and its whole body in course of its flight in the atmosphere and that's why real power and technical results of space PJE application for SC will be substantially less than theoretical ones.

In addition necessity of flight in superstandard layers besides degradation of power characteristics of propulsive engine functioning makes steep demands to construction and materials of the whole SC in connection with following problems:
very high temperatures;
heating of spacecraft in general and overheating of all front edges of air inlet in particular;
stationary and floating localized heating zones from shock waves;
high aerodynamic loads;
high load from pressure pulsations;
occurrence of serious flutter echo, vibrations, fluctuating loads of thermal origin;
erosion under the influence of oncoming air stream.

### SUMMARY

The technical task which proposed invention is aimed at is substantial reducing of costs for transporting cargo to the space at an account of creating the method and the system for feeding jet engines making it possible to perform reception and further forwarding of working substance/propellant stream without substantial energy losses and extreme influence on the construction, as well as net load increase at the account of reduction of on-board fuel stocks of a space craft.

The mentioned technical effect is reached with the aid of the proposed method and system for feeding jet engines. The method for feeding jet engines of spacecrafts consists in first launches of a spacecraft with a ramjet and a flying fueling apparatus with a stock of a working substance/propellant equipped with a system for throwing a jet of the working substance/propellant which carries out throwing of stocks of the working substance/propellant at a desired altitude. The flying fueling apparatus and the spacecraft approach each other with a speed which is greater than the speed of the working substance/propellant throwing. Furthermore, the system of flying fueling apparatus for throwing a jet forms working substance/propellant as cords representing a solid flexible propellant cord the density of which is greater than a density of the environmental air. Further the cords from the flying fueling apparatus enter a ramjet of the spacecraft with a speed which is greater than the speed of the jet ejection to produce thrust basing on consumption of chemical and/or kinetic energy of the cord.

The system for implementing the method comprises a spacecraft with a ramjet and a device for storing a working substance/propellant, a flying fueling apparatus equipped with a system for throwing a working substance/propellant.

The mentioned system for throwing forms a solid flexible propellant cord by means of introduction of one or more linear elements: ribbons, threads, or fibers, reticulate or membrane, of internal and external structures, as well as on a base of concentrated liquids and solid materials, or combinations of solid substances with liquid and/or gaseous ones, forming a flexible cord constructed with possibility of multiple or single use which is passing through the channel of the ramjet.

The proposed method for feeding jet engines of spacecrafts and the system for implementation of same makes it possible to eliminate defects of the aforementioned methods.

First, to diminish SC launching mass at an account of reduction of both on-board stocks of oxygen and combustible fuel component. Application of FFA as a source of working substance/propellant makes it possible to provide SC with all fuel components after start and to additionally increase the share of net load due to reduction of combustive components mass.

Secondly, to prevent losses of energy for compression in course of reception of working substance/propellant flow. In ordinary propulsive engines oxygen from atmospheric air is used as oxidizer which at hypersonic traverse speeds possible on high altitudes is in discharged state and requires compression to be used in the engine. Compression process is accompanied by irreversible losses of heat which are avoided in the proposed method. Oxygen or any other oxidizer is supplied in the state of high density not requiring additional compression.

Thirdly, to eliminate losses of energy on aerodynamic resistance to SC body and/or motor nacelle of a ramjet at hypersonic speeds (up to 50-60 M). Working substance supply not from atmosphere but from flying fueling apparatus makes it possible to realize acceleration of SC beyond the dense layers of the atmosphere on such altitudes where forces of aerodynamic resistance are not substantial.

Fourthly, to eliminate extreme loads on SC construction and materials caused by the necessity of acceleration in the atmosphere. Working substance supply with the help of FFA makes it possible to realize acceleration of SC on such altitudes where extreme loads on SC construction and materials don't occur.

Fifthly, to provide complete mixing and burning up of oxidizer with combustible on hypersonic speeds of fuel mixture by means of elimination of dimensioning and mass limitations on RAMJET in case of the engine installation in artificial satellite using ramjet thrust just to support constant speed without acceleration.

Sixthly, to reduce erosion loads on the engine's channel part caused by oxygen consumption under high temperatures as a part of working body. Instead of chemical energy of the working substance/propellant when moving at hypersonic speeds it is possible to use its kinetic energy according to the method proposed by I. A. Merkulov in those cases when the share of kinetic energy becomes commensurable with the share of chemical energy. Chemical fuel elimination solves the problem of engine protection from erosion in high-temperature stream of oxidizing environment.

Seventhly, to increase energy efficiency of SC acceleration by means of recuperation of its kinetic energy into the energy of working substance/propellant outflow according to the aforementioned method of I. A. Merkulov. Acceleration of SC and working substance/propellant jet relatively to each other up to the speeds commensurable with the first cosmic velocity and higher makes it possible to use their relative kinetic energy for working substance/propellant heating that provides specific pulse greater than those of thermochemical engines and comparable with pulse of nuclear hardphase engines.

The following detailed description is merely exemplary in nature and is not intended to limit the invention or the application and uses of the invention. All of the implementations described below are exemplary implementations provided to enable persons skilled in the art to make or use the invention and are not intended to limit the scope of the invention which is defined by the claims.

### BRIEF DESCRIPTION OF THE DRAWINGS

FIGS. 1, 2, 3, 4 show the system and working mode options.

FIG. 1 represents the system for implementing the method for feeding jet engines of spacecrafts;

FIGS. 2(a, b, c) represents variants of the working substance/propellant transmission for the engine of a spacecraft being launched from a planet into space:

FIG. 2a presents a variant of launching a cord made of working substance/propellant with giving it speed only in the vertical direction;

FIG. 2b presents a variant of launching a cord made of working substance/propellant with giving it speed in both directions; vertical and horizontal, with matching speed's direction of the cord to the spacecraft's movement direction;

FIG. 2c presents a variant of launching a cord made of working substance/propellant while giving it speed in both directions: vertical and horizontal with the counter cord's speed movement in relation to spacecrafts flight direction is presented.

FIG. 3 represents a variant of the working substance/propellant transmission for the engine of a spacecraft constantly located on the orbit of the artificial satellite of a planet and accumulating a part of entering working substance/propellant;

FIGS. 4(a, b, c) represents variants of transmission of the working substance/propellant of extraterrestrial origin for spacecraft's engine that starts from the planet into space:

FIG. 4a (on the left)—spacecraft acceleration by a counter flow of the working substance/propellant which was orbited in advance;

(on the right)—spacecraft acceleration by the catching up flow of the working substance/propellant which was put in orbit in advance;

FIG. 4b—the principle of work of the ramjet under a counter flow of working substance/propellant;

FIG. 4c—the principle of work of the ramjet under the catching up flow of working substance/propellant where:

1—spacecraft with propulsive jet engine/ramjet;

2—device for storing the working substance/propellant/propellant;

3—fueling apparatus;

4—the system of ejection of a solid flexible propellant cord;

5—the cord (a stabilized jet of the working substance/propellant);

6—spacecraft at the stage of initiatory acceleration;

7—spacecraft at the stage of work of the ramjet—creation of thrust by means of absorbing the working substance/propellant in the form of a cord and its further ejection;

8—fueling apparatus at the stage of initiatory acceleration;

9—the reel of fueling apparatus with a cord of working substance/propellant wound up around the reel, in the process of unrolling the cord into a line;

10—Earth's surface;

11—spacecraft's movement direction;

12—fueling apparatus's movement direction;

13—trajectory of the flight of the reels with cords made of working substance/propellant;

14—trajectory of the flight of the spacecraft;

15—movement direction of the propellant cords along the orbit around the planet;

16—movement direction of propellant cord from the ramjet;

17—movement direction of cords in relation to the spacecraft;

18—heated and evaporated flow of working substance/propellant (gas) within the channel of the ramjet;

19—gas, flowing out of the ramjet.

### DETAILED DESCRIPTION OF THE PREFERRED EMBODIMENTS

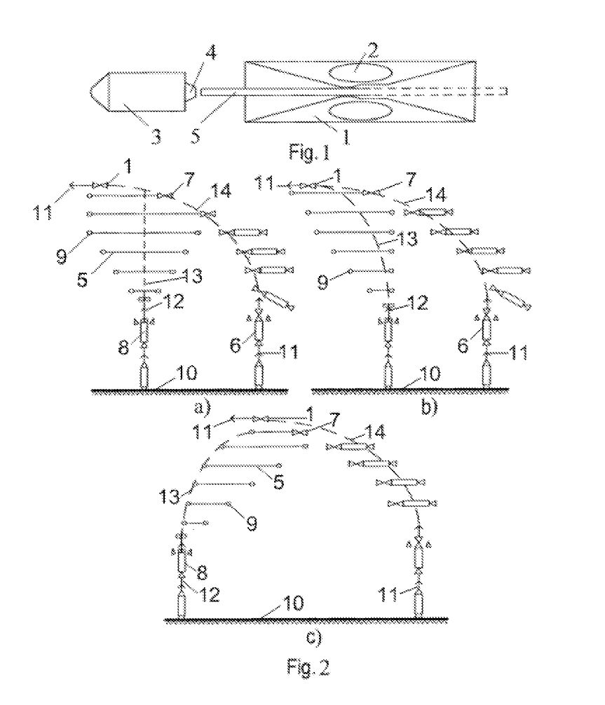

Implementation of the method for feeding jet engines of spacecrafts (FIG. 1). First, the SC equipped with a ramjet 1 and the device for storing working substance/propellant 2 is launched and the FFA with the main stock of working substance/propellant is also launched. At a desired altitude the FFA and the SC start to approach each other. In course of approaching a system for throwing a jet of working substance/propellant 4 ejects a solid flexible propellant cord (a cord) 5 within the recommended speed range from 30 to 300 m/s and the speed of the jet entrance into the ramjet is greater than the speed of its throwing so far as it is the resultant of the speeds of approaching of the FFA and the SC and the speed of jet throwing.

The jet stabilization is reached in different ways. In case of usage of liquid working substance/propellant like condensed oxygen (hydrogen peroxide, peroxide water solutions, water, nitrogen acid and other oxidizers) stabilization is provided by means of introduction into a flow of the formed jet of various linear elements: ribbons, threads, or fibers, reticulate or membrane, of internal and external structures, which at an account of fluid surface tension forces and/or external structures elasticity hold and fix it's form as a cord segmented with extension within the recommended range from 100 to 3000 m and in separate cases from 10 to 300 km. To reduce excessively high density of liquid oxidizer there can additionally be applied foaming of fluid with high foam rate from 200 to 1500-2000 units and to prevent boiling of fluid under conditions of space vacuum there applied the procedure of supercooling of fluids ejected by FFA.

Besides, for jet stabilization there can be applied the known methods of fluids thickening to jelly-like condition as well as there can be applied instead of fluids various pastes and plastic materials or ready-made and spooled on the cathead solid cords of working substance/propellant in the quality of which there can be used the known types of solid rocket fuel. In necessary cases in the quality of solid rocket fuel there can be used substances with increased combustion speed which is necessary at hypersonic speed of the cord entry into the engine and also with reduced density on the basis of giving the cord porous or cellular structure.

Throwing of cords of WS is fulfilled on such altitudes where significant forces of aerodynamic resistance to cords motion are absent. In case of creation of tracks from working substance/propellant cords from tens to hundreds kilometers length there can simultaneously be used several FFAs. Ejection process is over before the beginning of reception process taking place in the zone of future SC flight path, for the reason that the time period of WS cords absorption is considerably less than the time period of its forming so far as the process of the cord absorption by the engine is going at speeds starting from 1000 m/s and higher and the process of the cord forming goes at speeds from 30 to 300 m/s.

Reception of the working substance/propellant by the space craft, unlike the prototype, is fulfilled without preliminary compaction so far as the discharged cords of working substance/propellant are already formed by FFA with the required state of density that reduces irreversible losses of energy and rises efficiency of the engine.

In course of the working substance/propellant cord entrance into the engine different variants of its application for thrust production are possible.

In case if the working substance/propellant cord represents only oxidizer in the engine there takes place the process of mixing of oxidizer with combustible which is supplied to combustion chamber from on-board stocks of the device for storing the working substance/propellant of the spacecraft.

An amount of on-board fuel stocks can be considerably reduced if the cord of working substance/propellant represents a mixture of oxidizer and combustible, for example a mixture of liquid oxygen (hydrogen peroxide water solution, pure water or frozen carbonic acid) with powder-like aluminum, and from on-board stocks only part of combustible like for example hydrogen is supplied to combustion chamber.

There is a possible supply of a cord with complete set of all necessary fuel components that is performed both by supply of one cord representing a mixture of fuel components as well as by synchronous supply of two and more cords separately delivering fuel components like liquid oxygen and hydrogen which are combined in the combustion chamber that makes it possible to completely reduce on-board fuel stocks and increase the net load.

In addition to use of chemical energy of working substance/propellant cord it is also possible to use its kinetic energy by means of heating of the WS from the SC on-board stocks at an account of forces of friction with the cord surface during its passing through the engine working chamber. Furthermore the WS cord can be both for single and multiple use. The single use cord consists minimum from one substance which is mixed in the engine with the substance supplied from the device for storing the working substance/propellant and gets evaporated that excludes reusability of the cord. The multiple use cord including minimum one substance in solid state which doesn't get mixed with on-board working substance/propellant in course of its heating in the engine chamber and doesn't get collapsed, that's why the cord can be used repeatedly.

The working substance/propellant cord enters the ramjet in the amount necessary to produce the engine thrust providing the SC acceleration up to the desired speed in different ranges: from minimal possible speed to first cosmic or orbital velocity; keeping of the desired speed on the SC orbit; from first cosmic to second and third velocities.

There exist different variants of the method for transmission of working substance/propellant for spacecrafts' engines: for the SCs starting from a planet into space; for the SC permanently located on the orbit of a planet artificial satellite; for the SC starting from the orbit of a planet artificial satellite.

The methods for transmission of working substance/propellant for the SCs starting from a planet into space are presented on FIG. 2. The FFA and the SC are starting from a planet surface. After passing the dense layers of the atmosphere and reaching the desired altitude the FFA ejects the stocks of the working substance/propellant. The working substance/propellant is formed as a cord (a chain of segments of cords) which in the zone of the cord reception by the engine is oriented maximally parallel to the vector of horizontal constituent of the SC speed. Simultaneously with the process of the working substance/propellant cord formation there takes place approaching of the SC and the cord. Moreover, acceleration of the FFA and the SC on vertical line in course of the ballistic flight (moving under their inertia) is synchronous. The process is organized in such a way that after complete formation of the WS cord there takes place its meeting with the SC and there starts its entrance into the ramjet. Further there takes place drawing of the cord energy to the ramjet and acceleration of the SC along the cord (a chain of cords analogous to a dotted line formed by another FFAs).

It is possible to use both chemical energy of the cord, and its kinetic energy which makes it possible to get a higher specific pulse.

Using of chemical energy is reasonable when relative speeds of the WS cord entrance into the SC engine are equal or less than the first cosmic velocity according to the method of the working substance/propellant supply represented on FIGS. 2a, b. Here before its supply to the ramjet the WS cord can be preliminary accelerated by the FFA relative to a planet surface in the same direction where the SC is accelerated. Preliminary acceleration can be fulfilled up to the speeds of 4-6 km/s, reaching of which doesn't require big Tsiolkovsky's numbers and is possible on the basis of one-step rockets of multiple use. Such reduction of speed of the WS cord entrance into the ramjet can be topical for lowering of effect of thermochemical the ramjet degeneration arising on high speeds.

Kinetic energy is reasonable to be used when relative speeds of the WS cord entrance into the SC engine are higher than the first cosmic velocity according to the method of the working substance/propellant supply represented on FIG. 2c. Here before its supply to the ramjet the WS cord is preliminary accelerated by the FFA relative to a planet surface towards the SC. Moreover, before starting the WS reception, the SC can also preliminary accelerate in opposite direction relative to the FFA. Such preliminary acceleration in opposite direction can be performed up to the speeds of 4-6 km/s by each spacecraft, that provides the relative speed of the WS entrance into the SC engine within the limits of 8-12 km/s with low value of Tsiolkovsky's number of the FFA and the SC.

The process is completed by reaching the speed necessary for entrance into orbit of a planet satellite and/or into interplanetary flight path. The flying fuelling device which had suborbital speed returns back to a planet surface.

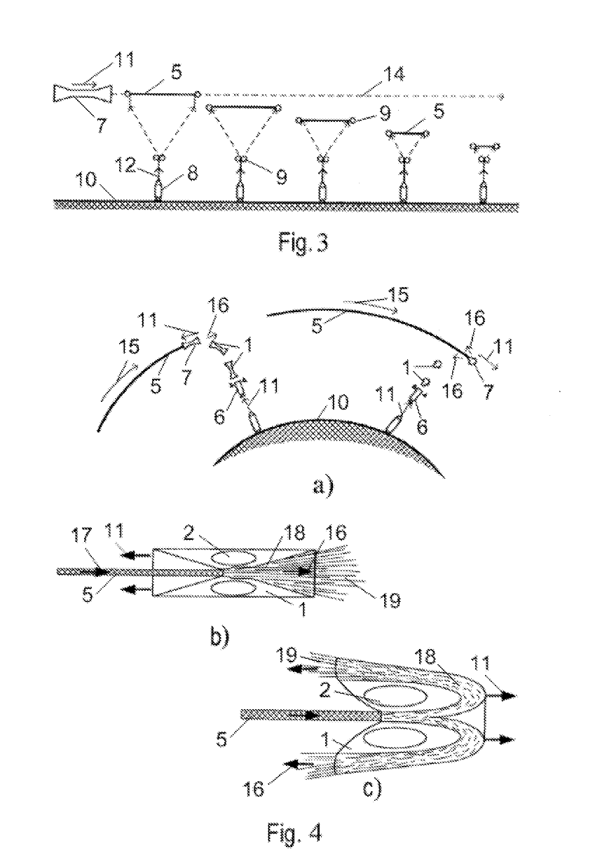

In the case when the SC is permanently located on the orbit of a planet artificial satellite the method for transmission of working substance/propellant is represented on FIG. 3. First on the orbit of a planet artificial satellite there parked a spacecraft equipped with a ramjet. From the planet surface, for example from the Earth, there fulfilled launches of flying fuelling apparatuses along suborbital trajectories with possibility of their intersection with the approaching SCs. At a desired altitude the FFA is discharging the stocks of the working substance/propellant in result of its ejection as a jet which is oriented maximally parallel to the SC motion path in reception zone. After this the FFA returns back to the planet. Ejection of the working substance/propellant cords is fulfilled in such a way that carrying on their movement along the ballistic trajectory they could appear before the SC as one or several cords (longitudinal and/or parallel) for the time period enough for its entrance into the SC ramjet, with recommended residual vertical velocity component in the range of 10-100 m/s. When entering the ramjet combustion chamber the fuel contained in the cord gets inflamed and produces a thrust in course of its expansion. A part of the fuel entering the engine doesn't get burned, but is picked out from the engine tract and gets accumulated on board the SC in the device for storing the working substance/propellant. The braking forces arising on picking out and accumulation of a part of working substance/propellant flowing through the SC ramjet are neutralized by the engine thrust. This in average provides constancy of the SC speed of movement along the orbit with consideration of neutralization of other possible braking forces (aerodynamical ones and others). The described process goes cyclically within the time limits determined by the ramjet resource with useful result of working substance/propellant mass increase on board the orbital SC. Usage of a satellite which doesn't need fuel consumption to remain on a certain altitude makes it possible to fulfill the working substance/propellant supply to it's engine not only in its constant duty but also with pauses which are used to prevent the engine overheating. Besides installation of the ramjet on the satellite makes it possible in contrast to its installation on starting apparatuses to apply such ramjets construction of which does not have any mass and dimensioning limitations.

In case when the SC is starting from the orbit of a planet artificial satellite the method of the working substance/propellant supply is represented on FIG. 4a. First on the orbit of a planet artificial satellite there parked a flying fuelling apparatus with fuel stock received directly on the orbit according to the method described above or in another way for example from the factories of the Moon or other heavenly bodies. On the desired orbit the FFA forms the working substance/propellant cords with their location in the space along the FFA flight path in ejection zone. Simultaneously with that from the planet surface, for example from the Earth, there fulfilled launches of SCs along suborbital trajectories with possibility of their intersection with orbital flows of the working substance/propellant in the form of cords. Having ascended the altitude of the orbit of the approaching working substance/propellant cords the speed of which is equal or exceeds the first cosmic velocity the space crafts are hovering at the desired altitude with the aid of vernier rocket engines for a time period (3-10 seconds) necessary for approaching to them of orbital flow of the working substance/propellant and its entrance into the ramjet.

There possible two sub-variants of the method of working substance/propellant transmission. The first one is: the flow of WS with orbital velocity enters the ramjet from the side of the SC head part and the apparatus starts its accelerated motion towards the flow which is going on till reaching the desired speed in the range of from the first cosmic velocity till the third one (FIG. 4b). The second one is: the WS flow catching up with the SC with orbital velocity enters the SC stern-part, makes a 180-degree turn with motion pulse transmission, then enters the ramjet combustion chamber where in course of it's burning up it produces thrust accelerating the SC in the same direction where movement of the WS orbital flow is directed to before reaching the desired speed (FIG. 4c).

As the working substance/propellant in the given cases there can be used carrying agents of chemical energy, as well as neutral substances carrying only kinetic energy production of which is fulfilled in accord with the aforementioned method of Merkulov with consumption of a part of working substance/propellant from the SC on-board stocks kept in the device for storing working substance/propellant.

The considered variant of the method of the working substance/propellant transmission for the spacecrafts engines as the kinetic source of energy permits application of the working substance/propellant cord of multiple use. Such a cord can be made for example of metals and is permanently located on the orbit of a planet artificial satellite in a pair with the FFA which at the same time is fulfilling functions of the cord towing accelerator. The SC launched either from a planet surface or from the orbit is grasping with its engine the cord moving towards it at relative speeds in the range of from 8 to 16 km/s in the beginning of acceleration on circular orbit and in the range of from 11 to 22 km/s on the elliptic one. When the metal cord is passing through the ramjet the working substance/propellant is brought into the engine chamber from the SC on-board stocks, for example as hydrogen or helium which are heated up by friction forces in the result of interaction with the cord and the chamber walls, that produces the thrust in course of gas exit from the ramjet. The length and the mass of the cord is selected in such a way as to make it possible in course of the cord passing through the ramjet for arising thrust force to provide acceleration of the SC up to the desired speed and for the cord not to get off from the orbit after passing the ramjet and transmission of a part of its kinetic energy to the SC. After leaving the ramjet the multiple-use cord is docking with the FFA which accelerates the cord up to the speed equal to the initial one and in such a way reimburses the initial stores of kinetic energy that makes it possible to realize acceleration of the next SC. Besides, the multiple-use cord can be used in combination with substances applied on it as single-mission coating which in course of the cord passing through the engine chamber is evaporated in course of interaction with substances from the SC on-board stocks and then produces a thrust when exiting the engine. The given method makes it possible to use substances of extraterrestrial origin for the SC launches, like for example those delivered to the Earth orbit from the Moon or asteroids as well as to reduce losses of the pulse of the multiple-use part of the cord.

The proposed method for working substance/propellant transmission to space crafts' engines is more profitable than the method of working substance/propellant supply from the atmosphere. Instead of oxygen and nitrogen mixture there can be supplied to engines just oxidizer without ballast substances that increases specific power, specific pulse and efficiency factor of the engines. Furthermore the oxidant-substance can be selected intentionally with consideration of the requirements on optimization of working processes in the ramjet. Simultaneously with the oxidizer the combustible can be supplied into the ramjet that makes it possible to launch the SC almost without fuel stocks. This, for example in case of air start application on the basis of a supersonic carrier-airplane or of another zero step makes it possible to load the SC with the net load on 70-80 percents of its launching mass, while in case of classical rockets the net load makes up 2-4 percents.

The working substance/propellant is supplied into the working chamber right with the density necessary for the ramjet functioning, that eliminates energy losses inevitable in case of air consumption under its dynamic compression in engine's diffuser. The working substance/propellant supply from FFA makes it possible to fulfill acceleration of the SC beyond the dense layers of the atmosphere and in this way to eliminate the forces of aerodynamic resistance and extreme thermal loads, that simplifies the SC construction, reduces its cost and increases its reliability.

Getting of WS not from atmosphere but from FFA makes it possible to transmit the working substance/propellant to the SC engines which are parked on the orbit of a planet artificial satellite and can accumulate a part of the WS entering into the ramjet. This allows to eliminate strict mass and dimensioning limitations on the ramjet construction as well as the limitation on interruption of the engine operation for cooling-down, which are not possible to be eliminated in case of the WS supply from the atmosphere that in result simplifies the ramjet construction, increases its safety index and endurance. The possibility to enlarge the ramjet linear dimensions is also favorable because of the fact that it eliminates problems of mixing of combustible with hypersonic flow of oxidizer and its burning up in a short time-period, which are typical in case of usage of ramjets with short areas of mixing and burning up zones.

Transmission of the working substance/propellant in composition of which oxidizer is preliminary mixed with combustible also eliminates the problem of the ramjet efficient functioning at hypersonic speeds.

In cases when due to the FFA motion the working substance/propellant can be transmitted to the SC engines with initially high speed the ramjet operation can be performed only on the basis of the WS kinetic energy without application of problematic processes of combustible burning up. In this case the engine can be saved from destructive impact of oxidizing substances under conditions of high temperatures and pressures that simplifies and makes cheaper the construction of the hypersonic ramjet. High speeds of the WS entrance into the ramjet, for example in the range of 8-12 km/s, are quite easy to get (without big Tsiolkovsky's numbers) on oncoming movement of the FFA and the SC by means of imparting to each of them the speed of 4-6 km/s relative to a planet.

The working substance/propellant transmission in the form of a multiple-use cord is profitable because the additional working substance/propellant used in a ramjet from the SC on-board stocks can practically have any molecular weight considering possibility of its acceleration up to the speed close to the speed of the cord movement in the engine chamber. Such types of on-board stocks of the WS as neon, argon, water, vaporous silicon, carbon etc. can be used in the ramjet considering possibility of reaching the outlet velocities from 8 km/s and higher depending on the speed of the cord passing through the engine chamber.

Application of the space-based FFA allows to use for the SC launching from a planet, for example from the Earth, kinetic energy of a substance of extraterrestrial origin, for example those delivered from small heavenly bodies for example from asteroids, from the Moon, or from other planets' natural satellites like for example Mars. This provides substantial energetic benefit at an account of the difference between the energy emitted by the WS in course of entrance into the engine of the SC starting from a planet and the energy consumed by the FFA for sending of substance from small heavenly bodies to the Earth.

What has been described above includes examples of the disclosed solution. It is, of course, not possible to describe every conceivable combination of components and/or methodologies, but one of ordinary skill in the art may recognize that many further combinations and permutations are possible. Accordingly, the claimed inventions are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for feeding a ramjet of a spacecraft beyond the dense layers of the atmosphere, the method comprising
providing a fueling apparatus having an amount of a propellant for feeding a ramjet of the spacecraft,
ejecting the propellant from the fueling apparatus in form of a solid and flexible propellant cord, wherein said propellant cord being placed on a flight path of the spacecraft,
allowing the solid and flexible propellant cord to enter into the ramjet of the spacecraft, and
using at least a part of a propellant of the solid and flexible propellant cord for feeding the ramjet.

2. The method of claim 1, further comprising storing at least a part of a propellant of the solid and flexible propellant cord in the spacecraft.

3. The method of claim 1, wherein the cord is ejected from the fueling apparatus, the cord enters into the ramjet with a entering speed being a resultant of the speeds of approaching of the fueling apparatus and the spacecraft and the speed of cord ejection, wherein the entering speed being greater than the ejection speed of the cord.

4. The method of claim 1, further comprising:
launching the fuelling apparatus along a suborbital trajectory, and
ejecting the solid and flexible propellant cord so as to ensure a cord movement along a ballistic trajectory with residual vertical velocity component in the range of 10-100 m/s before entering into the ramjet of the spacecraft.

5. The method of claim 4, wherein the cord is accelerated by the fuelling apparatus up to 6 km/s relative to a planet.

6. The method of claim 1, wherein the fueling apparatus is placed in an orbit of a planet's artificial satellite, the cord being accelerated by the fuelling apparatus towards to the spacecraft at relative speeds in the range from 8 to 16 km/s on circular orbit and in the range of from 11 to 22 km/s on the elliptic orbit.

7. The method of claim 3, wherein the cord enters into the ramjet at a head part of the spacecraft.

8. The method of claim 3, wherein the cord enters into the ramjet at a stern part of the spacecraft.

9. The method of claim 3, wherein the cord enters into the ramjet at hypersonic speeds, and wherein the method further comprises using a kinetic energy of the cord movement in the ramjet instead of a chemical energy of the propellant.

10. A solid and flexible propellant cord for feeding a ramjet of a spacecraft beyond the dense layers of the atmosphere, wherein the cord comprises an amount of a propellant stabilized in density relating to an environmental air by introducing one or more linear elements selected from ribbons, threads, or fibers, reticulate or membrane structures.
